(19) United States
(12) Patent Application Publication
(10) Pub. No.: US 2002/0036641 A1
(43) Pub. Date: Mar. 28, 2002

(54) Image storing method, image storing apparatus, ultrasonic diagnostics apparatus and contrast agent imaging method

(76) Inventor: Shinichi Amemiya, Tokyo (JP)

Correspondence Address: MOONRAY KOJIMA, BOX 627, WILLIAMSTOWN, MA, 01267, US

(21) Appl. No.: 09/919,163

(22) Filed: Jul. 31, 2001

(30) Foreign Application Priority Data
Sep. 26, 2000 (JP) 2000-292081

(51) Int. Cl. G06T 1/60

(52) U.S. Cl. 345/530

(57) ABSTRACT

For the purpose of storing images over a long time period, a cine memory is divided into a consecutive image storage region and a first inconsecutive image storage region. In the consecutive image storage region, the newest images are stored in a chronologically consecutive manner. In the first inconsecutive image storage region, images older than the images stored in the consecutive image storage region are stored in a chronologically inconsecutive manner.

### BACKGROUND OF THE INVENTION

The present invention relates to an image storing method, image storing apparatus, ultrasonic diagnosis apparatus and contrast agent imaging method, and more particularly to an imaging storing method, image storing apparatus and ultrasonic diagnosis apparatus capable of storing images over a long time period, and a contrast agent imaging method in which images from the time of contrast agent injection to the current time can be stored.

An ultrasonic diagnosis apparatus comprises a storage device of relatively high speed and small capacity generally referred to as a cine memory, and scans a subject to sequentially produce images while sequentially storing the images into the cine memory.

FIG. 1 is an explanatory diagram showing a method of storing images into a cine memory in a conventional ultrasonic diagnosis apparatus.

For convenience of explanation, the cine memory is described as being divided into containers in address order, each of which can store one image and is referred to as an entry space hereinbelow. The cine memory has six entry spaces in this example.

During times t1, t2, . . . , t6, images g1, g2, . . . , g6 are stored in order of time of production into the cine memory in order of the entry spaces.

During times t7, t8, . . . , t12, images g7, g8, . . . , g12 are sequentially overwritten on the entry spaces for the images g1, g2, . . . , g6.

Thereafter, the entry spaces of the cine memory are cyclically overwritten with the newest images.

In such a conventional ultrasonic diagnosis apparatus, there has been a problem that the number of past images preceding the newest image that can be stored into the cine memory is limited to the number of entry spaces of the cine memory. For example, when the cine memory has a storage capacity of 400 entry spaces and imaging is performed at a frame rate of 10 frames/second, the cine memory can store only the images for the most recent 40 seconds.

Accordingly, when imaging is performed over several minutes with a contrast agent injected into a subject, a problem arises that images at the beginning of the injection are lost despite the fact that these images are diagnostically important.

### SUMMARY OF THE INVENTION

Therefore, it is a first object of the present invention to provide an image storing method, image storing apparatus and ultrasonic diagnosis apparatus capable of storing images over a longer time period as compared with the conventional technique.

Moreover, it is a second object of the present invention to provide a contrast agent imaging method in which when imaging is performed over several minutes with a contrast agent injected into a subject, images at the beginning of the injection are not lost.

In accordance with a first aspect, the present invention provides an image storing method characterized in comprising: storing a newest image and a plurality of chronologically consecutive old images preceding said newest image; and storing a plurality of chronologically inconsecutive images older than the oldest one of said chronologically consecutive images.

According to the image storing method in the first aspect, since the newest image and a group of images extending consecutively into the past from the newest image are stored in combination with a group of chronologically inconsecutive images preceding those images, images over a long time period can be stored notwithstanding that the number of storable images is limited by storage capacity. The group of images close to the newest image allows subtle changes to be reviewed because these images are consecutive. The group of images older than the former group allows long-term changes to be roughly reviewed because these images are inconsecutive.

When stored images are cine-displayed, the display interval is preferably adjusted to correspond to the imaging time interval between a currently displayed image and an image to be displayed next.

In accordance with a second aspect, the present invention provides the image storing method of the foregoing configuration, characterized in comprising: dividing a storage region into a consecutive image storage region and an inconsecutive image storage region; sequentially storing the newest image and a plurality of chronologically consecutive old images preceding said newest image in order of the entry spaces into said consecutive image storage region; sequentially storing a plurality of chronologically inconsecutive images older than the oldest one of the images stored in said consecutive image storage region in order of the entry spaces into said inconsecutive image storage region; deleting an image in an entry space determined in response to a current image storage pattern in the storage region; sequentially shifting images in entry spaces subsequent to said entry space forward; and storing the newest image into the last entry space in said consecutive image storage region.

According to the image storing method in the second aspect, since storage is performed with the order of entry space in the storage region and the order of time matched, cine display can be easily achieved by reading out entry spaces in order.

In accordance with a third aspect, the present invention provides the image storing method of the foregoing configuration, characterized in comprising: overwriting the newest image on an entry space determined in response to the current image storage pattern in the storage region.

According to the image storing method in the third aspect, since stored images need not be shifted among the entry spaces, overhead of storage processing can be reduced.

In accordance with a fourth aspect, the present invention provides the image storing method of the foregoing configuration, characterized in comprising: dividing a storage region into a consecutive image storage region, an inconsecutive image storage region and an oldest image storage region; storing a plurality of chronologically consecutive images into said oldest image storage region at the start of image storing; storing the newest image and a plurality of chronologically consecutive old images preceding said newest image into said consecutive image storage region; and storing a plurality of chronologically inconsecutive images older than the oldest one of the images stored in said consecutive image storage region into said inconsecutive image storage region.

When imaging is performed with a contrast agent injected into a subject, images at the beginning of the injection are diagnostically important.

According to the image storing method in the fourth aspect, since images at the start of recording are consecutively stored in the oldest image storage region, the images at the beginning of contrast agent injection can be reviewed later, allowing diagnosis using a contrast agent to be suitably performed.

In accordance with a fifth aspect, the present invention provides the image storing method of the foregoing configuration, characterized in that said inconsecutive image storage region consists of a plurality of inconsecutive image storage subregions having different skip numbers.

According to the image storing method in the fifth aspect, the desired fineness of change observation and the desired period of observation can easily be harmonized.

In accordance with a sixth aspect, the present invention provides an image storing apparatus characterized in comprising: image storing means for storing the newest image and a plurality of chronologically consecutive old images preceding said newest image, and storing a plurality of chronologically inconsecutive images older than the oldest one of said chronologically consecutive images; and storage updating means for selecting one of the stored images, deleting the image, and storing the newest image.

According to the image storing apparatus in the sixth aspect, the image storing method in the first aspect can be suitably performed.

In accordance with a seventh aspect, the present invention provides the image storing apparatus of the foregoing configuration, characterized in that: said image storing means consists of consecutive image storing means and inconsecutive image storing means, sequentially stores the newest image and a plurality of chronologically consecutive old images preceding said newest image in order of the entry spaces into said consecutive image storing means, and sequentially stores a plurality of chronologically inconsecutive images older than the oldest one of the images stored in said consecutive image storing means in order of the entry spaces into said inconsecutive image storing means; and said storage updating means deletes an image in an entry space determined in response to a current image storage pattern of said image storing means, sequentially shifts images in entry spaces subsequent to said entry space forward, and stores the newest image into the last entry space in said consecutive image storing means.

According to the image storing apparatus in the seventh aspect, the image storing method in the second aspect can be suitably performed.

In accordance with an eighth aspect, the present invention provides the image storing apparatus of the foregoing configuration, characterized in that: said storage updating means overwrites the newest image on an entry space determined in response to the current image storage pattern of said image storing means.

According to the image storing apparatus in the eighth aspect, the image storing method in the third aspect can be suitably performed.

In accordance with a ninth aspect, the present invention provides the image storing apparatus of the foregoing configuration, characterized in that: said image storing means consists of consecutive image storing means, inconsecutive image storing means and oldest storing means, stores a plurality of chronologically consecutive images into said oldest storing means at the start of image storing, stores the newest image and a plurality of chronologically consecutive old images preceding said newest image into said consecutive image storing means, and stores a plurality of chronologically inconsecutive images older than the oldest one of the images stored in said consecutive image storing means into said inconsecutive image storing means.

According to the image storing apparatus in the ninth aspect, the image storing method in the fourth aspect can be suitably performed.

In accordance with a tenth aspect, the present invention provides the image storing apparatus of the foregoing configuration, characterized in that said inconsecutive image storing means consists of a plurality of inconsecutive image storing sub-means having different skip numbers.

According to the image storing apparatus in the tenth aspect, the image storing apparatus in the fifth aspect can be suitably performed.

In accordance with an eleventh aspect, the present invention provides the image storing apparatus of the foregoing configuration, characterized in that said consecutive image storing means is provided in a first storage device with relatively high speed and small capacity, and at least part of said inconsecutive image storing means is provided in a second storage device with relatively low speed and large capacity.

According to the image storing apparatus in the eleventh aspect, the newest images produced in real time can be recorded in the consecutive image storing means at a high speed, and images older than the newest images can be stored in the inconsecutive image storing means in large quantities.

In accordance with a twelfth aspect, the present invention provides the image storing apparatus of the foregoing configuration, characterized in that said first storage device stores images in a first image format, and said second storage device stores images in a second image format different from said first image format.

According to the image storing apparatus in the twelfth aspect, it is possible to, for example, store images into the first storage device in a first image format suitable for image production, and store images into the second storage device in a second image format suitable for image display.

In accordance with a thirteenth aspect, the present invention provides an ultrasonic diagnosis apparatus characterized in comprising the image storing apparatus of any of the foregoing configurations.

According to the ultrasonic diagnosis apparatus in the thirteenth aspect, images over a longer time period than by a conventional technique can be stored.

In accordance with a fourteenth aspect, the present invention provides an ultrasonic diagnosis apparatus characterized in that: the apparatus comprises the image storing apparatus of any of the foregoing configurations; said first storage device is a cine memory; said first image format is an image format on an acoustic line basis; said second storage device is a hard disk; and said second image format is an image format on a screen picture element basis.

According to the ultrasonic diagnosis apparatus in the fourteenth aspect, the newest images produced in real time can be recorded at a high speed in an image format on an acoustic line basis suitable for image production, and images older than the newest images can be stored in large quantities in an image format on a screen picture element basis suitable for image display.

It should be noted that by the term “image format on an acoustic line basis” is meant a format for constructing an image as an acoustic line data set, and by the term “image format on a screen picture element basis” is meant a format for constructing an image as a data set of picture elements constituting a screen.

In accordance with a fifteenth aspect, the present invention provides a contrast agent imaging method characterized in comprising: injecting a contrast agent into a subject; and performing imaging using an ultrasonic diagnosis apparatus comprising the image storing apparatus of any of the foregoing configurations.

According to the contrast agent imaging method in the fifteenth aspect, since images at the start of recording can be consecutively stored, the images at the beginning of contrast agent injection can be reviewed later, allowing diagnosis using a contrast agent to be suitably performed.

According to the image storing method, image storing apparatus and ultrasonic diagnosis apparatus of the present invention, since a group of images close to the latest time is consecutively stored, and a group of images preceding that group of images is stored in a chronologically thinned-out manner, images over a long time period can be stored notwithstanding that the number of storable images is limited by storage capacity. The group of images close to the newest image allows subtle changes to be observed because these images are consecutive. The group of images older than the former group allows long-term changes to be roughly observed because these images are inconsecutive.

According to the ultrasonic diagnosis apparatus and contrast agent imaging method of the present invention, since images at the start of recording can be consecutively stored, diagnostically important images at the start of contrast agent injection can be reviewed later, allowing diagnosis using a contrast agent to be suitably performed.

Further objects and advantages of the present invention will be apparent from the following description of the preferred embodiments of the invention as illustrated in the accompanying drawings.

### BRIEF DESCRIPTION OF THE DRAWINGS

FIG. 1 is an explanatory diagram illustrating the change in contents stored in a cine memory in accordance with a conventional ultrasonic diagnosis apparatus.

FIG. 2 is a configuration diagram illustrating an ultrasonic diagnosis apparatus in accordance with a first embodiment.

FIG. 3 is a schematic diagram illustrating the configuration of a cine memory in accordance with the first embodiment.

FIG. 4 is a flow chart illustrating image display processing in accordance with the first embodiment.

FIG. 5 is an explanatory diagram illustrating the change in contents stored in the cine memory in accordance with the first embodiment.

FIG. 6 is a flow chart illustrating image display processing in accordance with a second embodiment.

FIG. 7 is an explanatory diagram illustrating the change in contents stored in the cine memory in accordance with the second embodiment.

FIG. 8 is a schematic diagram illustrating the configuration of the cine memory in accordance with a third embodiment.

FIG. 9 is a flow chart illustrating image display processing in accordance with the third embodiment.

FIG. 10 is an explanatory diagram illustrating the change in contents stored in the cine memory in accordance with the third embodiment.

FIG. 11 is a schematic diagram illustrating the configuration of the cine memory in accordance with a fourth embodiment.

FIG. 12 is a flow chart illustrating image display processing in accordance with the fourth embodiment.

FIG. 13 is a flow chart continued from FIG. 11.

FIG. 14 is an explanatory diagram illustrating the change in contents stored in the cine memory in accordance with the fourth embodiment.

FIG. 15 is an explanatory diagram continued from FIG. 13.

FIG. 16 is a configuration diagram illustrating an ultrasonic diagnosis apparatus in accordance with a fifth embodiment.

FIG. 17 is a schematic diagram illustrating the configuration of a cine memory in accordance with the fifth embodiment.

FIG. 18 is a flow chart illustrating image display processing in accordance with the fifth embodiment.

FIG. 19 is an explanatory diagram illustrating the change in contents stored in the cine memory in accordance with the fifth embodiment.

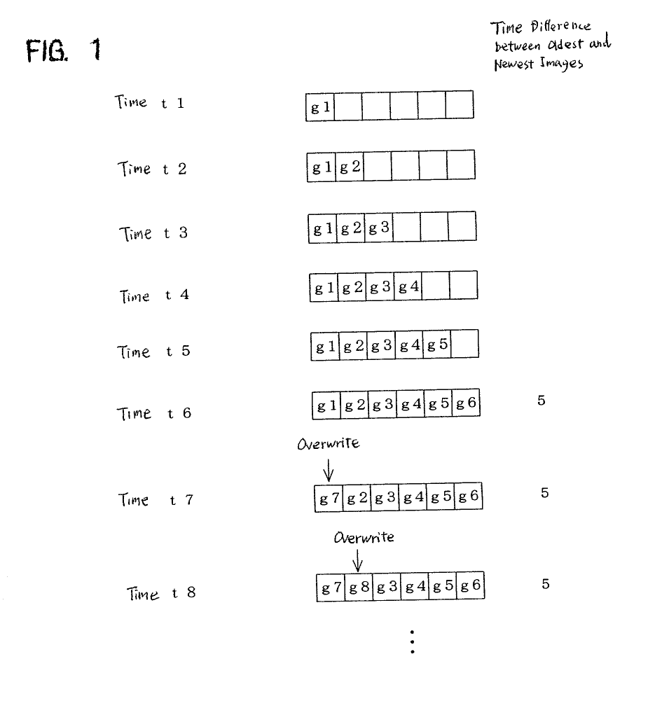

### DETAILED DESCRIPTION OF THE INVENTION

The present invention will now be described in more detail with reference to embodiments shown in the accompanying drawings. It should be noted that the present invention is not limited to these embodiments.

### First Embodiment

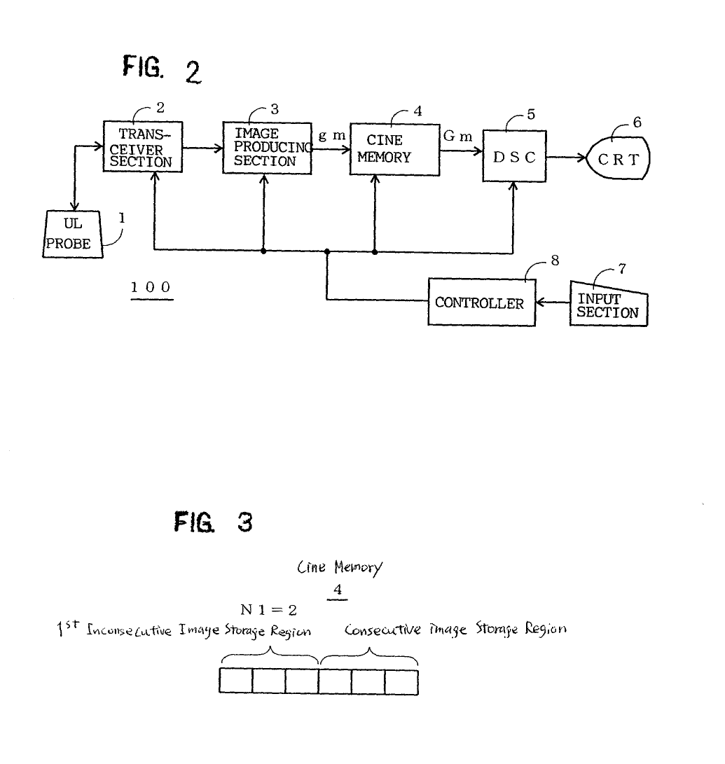

FIG. 2 is a configuration diagram illustrating an ultrasonic diagnosis apparatus 100 in accordance with a first embodiment of the present invention.

The ultrasonic diagnosis apparatus 100 comprises an ultrasonic probe 1; a transceiver section 2 for driving the ultrasonic probe 1 to transmit ultrasound and receive echoes, and outputting receive signals based on the echoes; an image producing section 3 for producing images gm (m=1, 2, . . . ) on an acoustic line basis from the receive signals; a cine memory 4 for storing multiple images gm; a DSC 5 for converting the images gm stored in the cine memory 4 into images Gm on a screen picture element basis (such as B-mode images, color flow mapping mode images, or power Doppler mode images); a CRT 6 for displaying the images Gm; an input section 7 for a human operator to input instructions; and a controller 8 for controlling the storage of images into the cine memory 4 and controlling the entire apparatus.

FIG. 3 is a schematic diagram showing the configuration of the cine memory 4 in accordance with the first embodiment.

The cine memory 4 consists of a consecutive image storage region and a first inconsecutive image storage region.

In the consecutive image storage region, a plurality of chronologically consecutive images are stored starting from the newest image.

In the first inconsecutive image storage region, a plurality of chronologically alternate images (every other image in chronological order) older than the oldest one of the images stored in the consecutive image storage region are stored. When the alternate images are stored, the time interval between adjacent images is defined as “2”. This is expressed as a skip interval N1=2.

For convenience of explanation, the cine memory 4 is described as being divided into containers in address order, each of which can store one image and is referred to as an entry space hereinbelow. The cine memory 4 is described as having six entry spaces, in which the consecutive image storage region has three entry spaces and the first inconsecutive image storage region has three entry spaces.

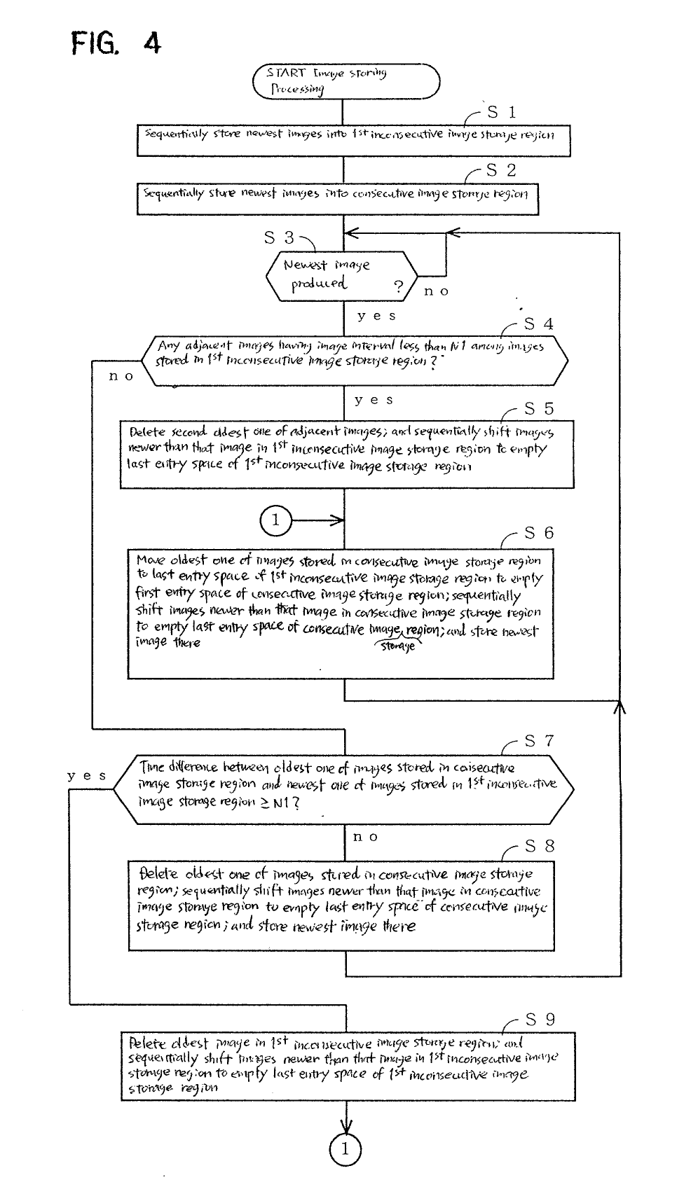

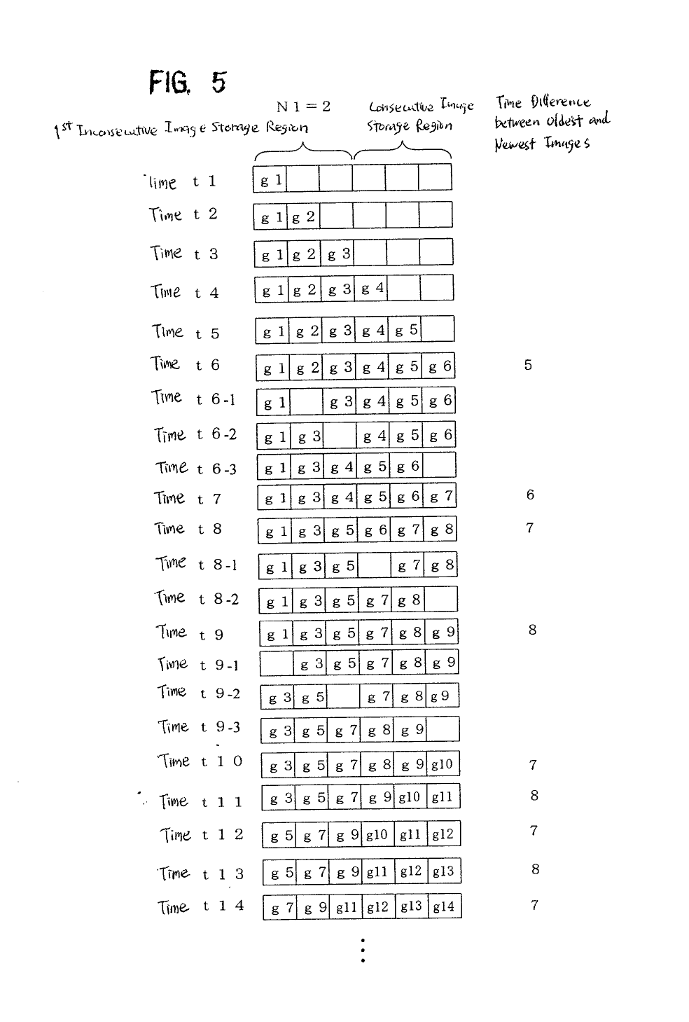

FIG. 4 is a flow chart illustrating image storing processing in accordance with the first embodiment.

In Step S1, the newest images are stored into the first inconsecutive image storage region in order of the entry spaces until the region becomes full, as shown at times t1-t3 in FIG. 4.

In Step S2, the newest images are stored into the consecutive image storage region in order of the entry spaces until the region becomes full, as shown at times t4-t6 in FIG. 4.

In Step S3, when a newest image is produced, the process goes to Step S4.

In Step S4, the images stored in the first inconsecutive image storage region are searched for adjacent images having an image interval less than “2”. If such adjacent images are found, the process goes to Step S5; otherwise to Step S7. Before the newest image at time t7 in FIG. 4 is stored, the status is at time t6 and the image interval between g1 and g2 is “1”, which is less than “2”. Therefore, g1 and g2 are considered as adjacent images and the process goes to Step S5.

In Step S5, the second oldest one of the adjacent images is deleted, and the images newer than that image in the first inconsecutive image storage region are sequentially shifted to empty the last entry space of the first inconsecutive image storage region. Before the newest image at time t7 in FIG. 5 is stored, g1 and g2 are adjacent images. Therefore, g2 is deleted as shown at time t6-1 in FIG. 5, and g3 is shifted forward to empty the last entry space of the first inconsecutive image storage region as shown at time t6-2 in FIG. 5.

In Step S6, the oldest one of the images stored in the consecutive image storage region is moved to the last entry space of the first inconsecutive image storage region to empty the first entry space of the consecutive image storage region; the newer images than that image in the consecutive image storage region are sequentially shifted to empty the last entry space of the consecutive image storage region; and the newest image is stored there. Before the newest image at time t7 in FIG. 5 is stored, g4 is moved to the last entry space of the first inconsecutive image storage region to empty the first entry space of the consecutive image storage region, and g5 and g6 are sequentially shifted forward to empty the last entry space of the consecutive image storage region, as shown at time t6-3. Then, the newest image g7 is stored into the last entry space of the consecutive image storage region as shown at t7 in FIG. 5. The process then goes back to Step S3.

At time t8 in FIG. 5, g4 shown at time t7 is deleted, g5-g7 are shifted forward, and the newest image g8 is stored into the last entry space of the consecutive image storage region by Steps S4-S6.

Before the newest image at time t9 in FIG. 4 is stored, the status is at time t8, and therefore the process goes from Step S4 to Step S7.

In Step S7, a decision is made on whether the time difference between the oldest one of the images stored in the consecutive image storage region and the newest one of the images stored in the first inconsecutive image storage region is equal to or more than “2”, and if it is not equal to or more than “2”, the process goes to Step S8; otherwise to Step S9. Before the newest image at time t9 in FIG. 5 is stored, the status is at time t8 and the time difference is “1”, which is not equal to or more than “2”. Therefore, the process goes to Step S8.

In Step S8, the oldest one of the images stored in the consecutive image storage region is deleted, the newer images than that image in the consecutive image storage region are sequentially shifted to empty the last entry space of the consecutive image storage region, and the newest image is stored there. Before the newest image at time t9 in FIG. 5 is stored, g6 is deleted to empty the first entry space of the consecutive image storage region as shown at time t8-1 in FIG. 5, and g7 and g8 are sequentially shifted forward to empty the last entry space of the consecutive image storage region as shown at time t8-2 in FIG. 5. Then, the newest image g9 is stored into the last entry space of the consecutive image storage region as shown at t9 in FIG. 5. The process then goes back to Step S3.

Before the newest image at time t10 in FIG. 5 is stored, the status is at time t9, and therefore the process goes from Step S7 to Step S9.

In Step S9, the oldest image in the first inconsecutive image storage region is deleted, and the newer images than that image in the first inconsecutive image storage region are sequentially shifted to empty the last entry space of the first inconsecutive image storage region. Then, the process goes back to Step S6. Before the newest image at time t10 in FIG. 5 is stored, g1 is deleted to empty the first entry space of the first inconsecutive image storage region as shown at time t9-1 in FIG. 5, and g3 and g5 are sequentially shifted forward to empty the last entry space of the first inconsecutive image storage region as shown at time t9-2 in FIG. 5. The process then goes back to Step S6.

Upon returning to Step S6, g7 is moved to the last entry space in the first inconsecutive image storage region to empty the first entry space of the consecutive image storage region, and g8 and g9 are sequentially shifted forward to empty the last entry space of the consecutive image storage region as shown at time t9-3 in FIG. 5. Then, the newest image g10 is stored into the last entry space of the consecutive image storage region as shown at t10 in FIG. 5. Then, the process goes back to Step S3.

By storing images in a similar way thereafter, images over a longer time period as compared with the conventional technique can be stored.

Although the number of entry spaces in the cine memory 4 was “6” in the preceding description, it is generally of the order of from several tens to several hundreds.

For example, if the number of entry spaces is “400” in which “50” entry spaces are assigned to the consecutive image storage region and “350” entry spaces are assigned to the first inconsecutive image storage region, N1=6, and if imaging is performed at a frame rate of 10 frames/second, then images over the latest five seconds can be stored in the consecutive image storage region, and images over the past three minutes at maximum can be stored in the first inconsecutive image storage region. In contrast, the conventional method allows images over only 40 seconds to be recorded. Since there is a need to reproduce images over about three minutes after a contrast agent is injected into a subject, the present invention can respond to this need.

### Second Embodiment

The second embodiment is the same as the first embodiment regarding the configuration of FIGS. 2 and 3.

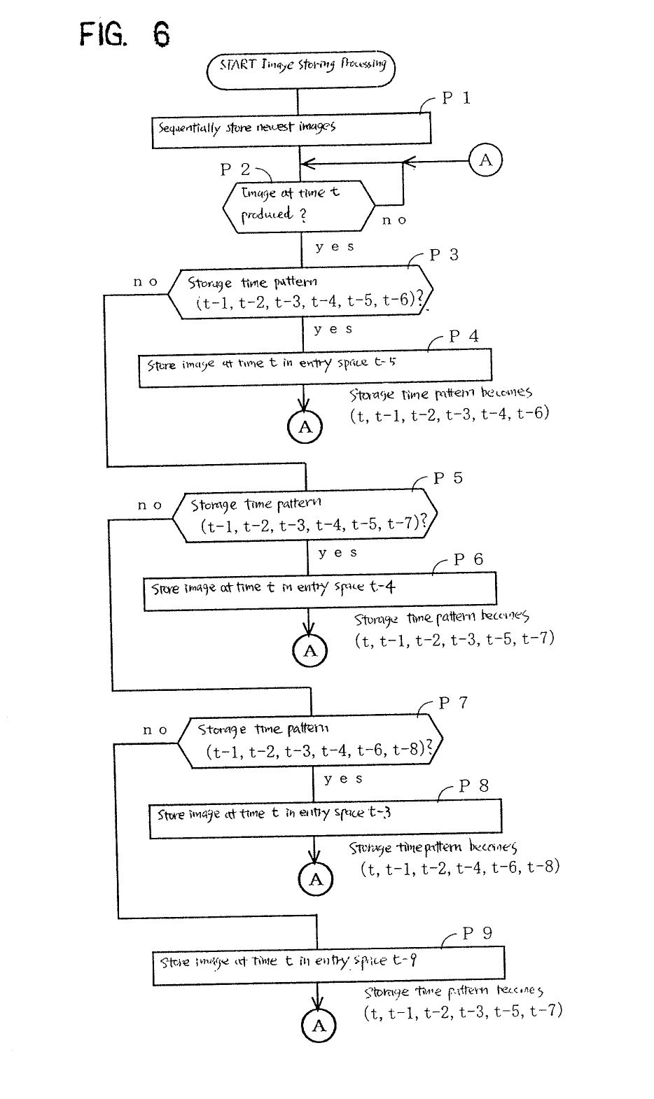

FIG. 6 is a flow chart illustrating image storing processing in accordance with the second embodiment.

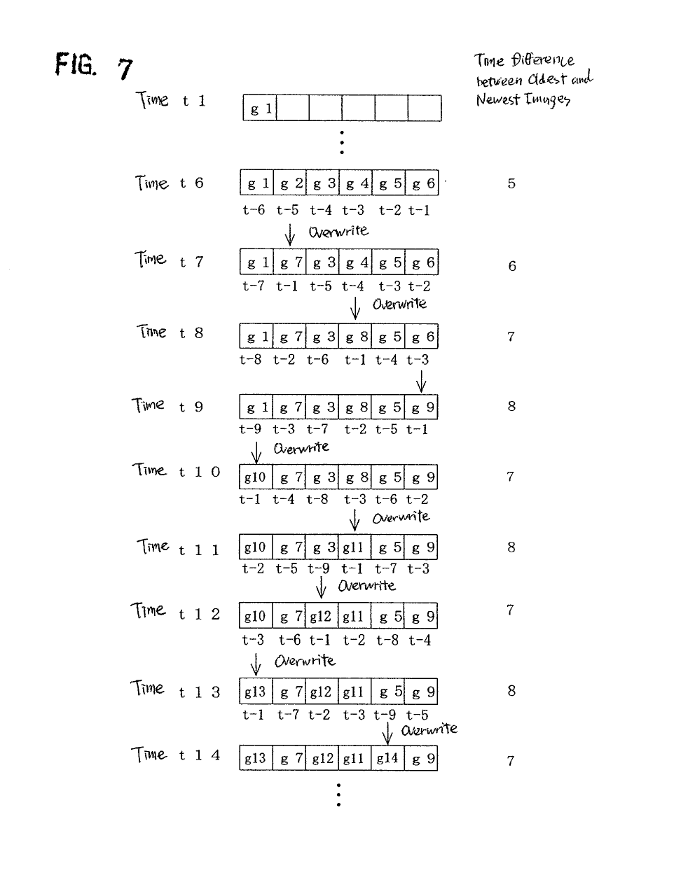

In Step P1, the newest images are sequentially stored into entry spaces of the cine memory 4 as shown at times t1-t6 in FIG. 7.

In Step P2, when the newest image at time t is produced, the process goes to Step P3.

In Step P3, if a storage time pattern, i.e., a pattern of times of stored images, is (t-1, t-2, t-3, t-4, t-5, t-6), the process goes to Step P4; otherwise to Step P5. Before an image at time t7 is stored, the status is at time t6, and therefore the process goes to Step P4.

In Step P4, an image g7 at time t7 is stored in an entry space that stored an image at time t-5, as shown at time t7 in FIG. 7. Then, the process goes back to Step P2.

Before an image at time t8 is stored, the status is at time t7, and therefore the process goes from Step P3 to Step P5.

In Step P5, if the storage time pattern is (t-1, t-2, t-3, t-4, t-5, t-7), the process goes to Step P6; otherwise to Step P7. Before an image at time t8 is stored, the status is at time t7, and therefore the process goes to Step P6.

In Step P6, an image g8 at time t8 is stored in an entry space that stored an image at time t-4, as shown at time t8 in FIG. 7. Then, the process goes back to Step P2.

Before an image at time t9 is stored, the status is at time t8, and therefore the process goes from Step P3 to Step P5, and then goes from Step P5 to Step P7.

In Step P7, if the storage time pattern is (t-1, t-2, t-3, t-4, t-6, t-8), the process goes to Step P8; otherwise to Step P9. Before an image at time t9 is stored, the status is at time t8, and therefore the process goes to Step P8.

In Step P8, an image g9 at time t9 is stored in an entry space that stored an image at time t-3, as shown at time t9 in FIG. 7. Then, the process goes back to Step P2.

Before an image at time t10 is stored, the status is at time t9, and therefore the process goes from Step P3 to Step P5, then goes from Step P5 to Step P7, and further goes from P7 to Step P9.

In Step P9, an image g10 at time t10 is stored in an entry space that stored an image at time t-9, as shown at time t10 in FIG. 7. Then, the process goes back to Step P2.

By storing images in a similar way thereafter, images over a longer time period as compared with the conventional technique can be stored.

Although the number of entry spaces in the cine memory 4 was “6” in the preceding description, it is generally of the order of from several tens to several hundreds.

For example, if the number of entry spaces is “400” in which “50” entry spaces are assigned to the consecutive image storage region and “350” entry spaces are assigned to the first inconsecutive image storage region, N1=6, and if imaging is performed at a frame rate of 10 frames/second, then images over the latest five seconds can be stored in the consecutive image storage region, and images over the past three minutes at maximum can be stored in the first inconsecutive image storage region. In contrast, the conventional method allows images over only 40 seconds to be recorded. Since there is a need to reproduce images over about three minutes after a contrast agent is injected into a subject, the present invention can respond to this need.

### Third Embodiment

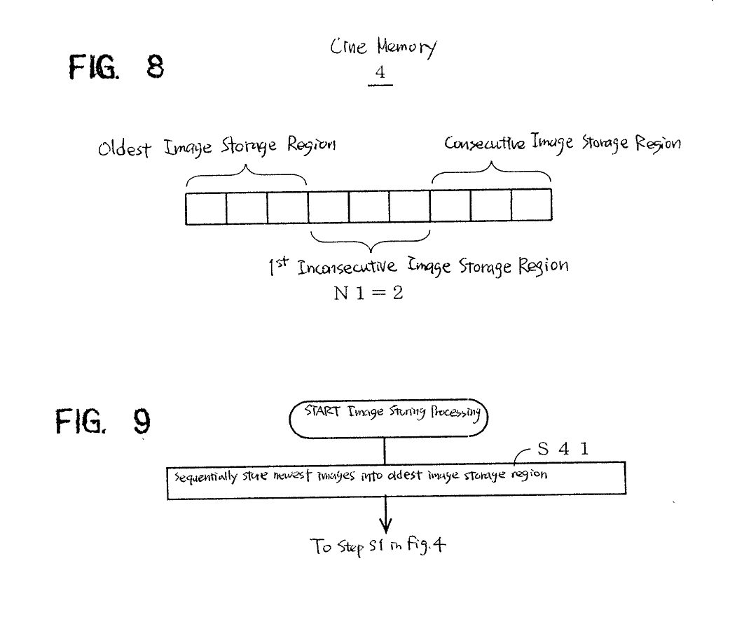

The third embodiment is the same as in the third embodiment regarding the configuration of FIG. 8.

FIG. 3 is a schematic diagram illustrating the configuration of the cine memory 4 in accordance with the first embodiment.

The cine memory 4 consists of a consecutive image storage region, a first inconsecutive image storage region and an oldest image storage region.

In the consecutive image storage region, a plurality of chronologically consecutive images are stored starting from the newest image.

In the first inconsecutive image storage region, a plurality of chronologically alternate images older than the oldest one of the images stored in the consecutive image storage region are stored. When the alternate images are stored, the time interval between adjacent images is defined as “2”. This is expressed as a skip interval N1=2.

In the oldest image storage region, a plurality of chronologically consecutive images at the start of image storing are stored.

For convenience of explanation, the cine memory 4 is described as being divided into containers in address order, each of which can store one image and is referred to as an entry space hereinbelow. The cine memory 4 is described as having nine entry spaces, in which the consecutive image storage region has three entry spaces, the first inconsecutive image storage region has three entry spaces, and the oldest image storage region has three entry spaces.

FIG. 9 is a flow chart illustrating image storing processing in accordance with the third embodiment.

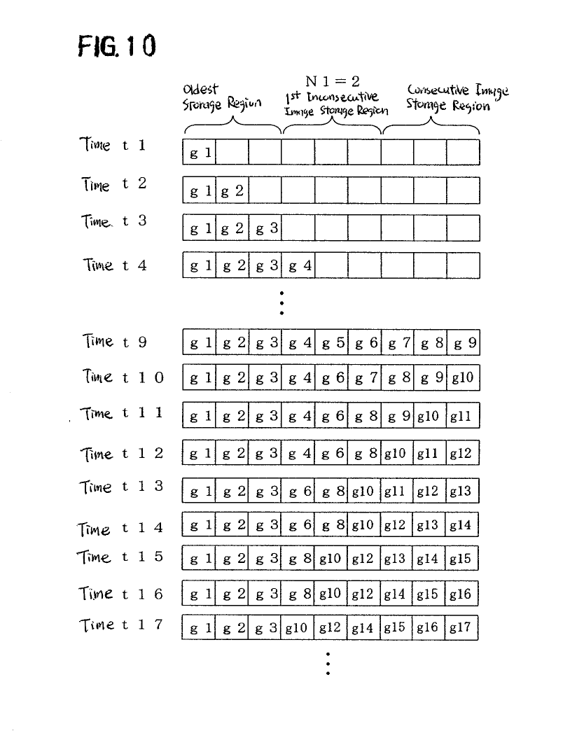

In Step S41, the newest images are sequentially stored into the oldest image storage region of the cine memory 4 until the region becomes full, as shown at times t1-t3 in FIG. 10. The process then goes to Step S1 of FIG. 4.

By storing images in a way similar to that in the first embodiment thereafter, images over a longer time period past from the newest image can be stored while preserving images at the start of recording in the oldest image storage region. Thus, by injecting a contrast agent into a subject and starting imaging, the images at the start of the contrast agent injection can be reviewed later, allowing diagnosis using the contrast agent to be suitably performed.

Although the number of entry spaces in the cine memory 4 was “9” in the preceding description, it is generally of the order of from several tens to several hundreds.

For example, if the number of entry spaces is “400” in which “50” entry spaces are assigned to the consecutive image storage region, “300” entry spaces are assigned to the first inconsecutive image storage region and “50” entry spaces are assigned to the oldest image storage region, N1=6, and if imaging is performed at a frame rate of 10 frames/second, then images over the latest five seconds can be stored in the consecutive image storage region, images over the intermediate three minutes at maximum can be stored in the first inconsecutive image storage region, and images over the first five seconds can be stored in the oldest image storage region. In contrast, the conventional method allows images over only 40 seconds to be recorded. Since there is a need to reproduce images over about three minutes after a contrast agent is injected into a subject, the present invention can respond to this need. Moreover, subtle changes during the first five seconds at the start of the contrast agent injection can be observed.

### Fourth Embodiment

The fourth embodiment is the same as the first embodiment regarding the configuration of FIG. 2.

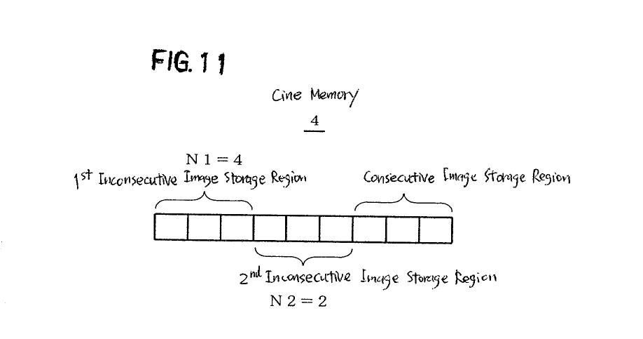

FIG. 11 is a schematic diagram showing the configuration of the cine memory 4 in accordance with the fourth embodiment.

The cine memory 4 consists of a consecutive image storage region, a second inconsecutive image storage region and a first inconsecutive image storage region.

In the consecutive image storage region, a plurality of chronologically consecutive images are stored starting from the newest image.

In the second inconsecutive image storage region, a plurality of chronologically alternate images older than the oldest one of the images stored in the consecutive image storage region are stored. When the alternate images are stored, the time interval between adjacent images is defined as “2”. This is expressed as a skip interval N2=2.

In the first inconsecutive image storage region, a plurality of images which are older than the oldest one of the images stored in the second inconsecutive image storage region and which are alternate with respect to the image interval of the second inconsecutive image storage region are stored. This is expressed as a skip interval N1=2·N2. This is equivalent to a skip interval N1=4 because a plurality of chronologically ordered images made up of every fourth image are stored with respect to the image interval for the consecutive image storage region.

For convenience of explanation, the cine memory 4 is described as being divided into containers in address order, each of which can store one image and is referred to as an entry space hereinbelow. The cine memory 4 is described as having nine entry spaces, in which the consecutive image storage region has three entry spaces, the second inconsecutive image storage region has three entry spaces, and the first inconsecutive image storage region has three entry spaces.

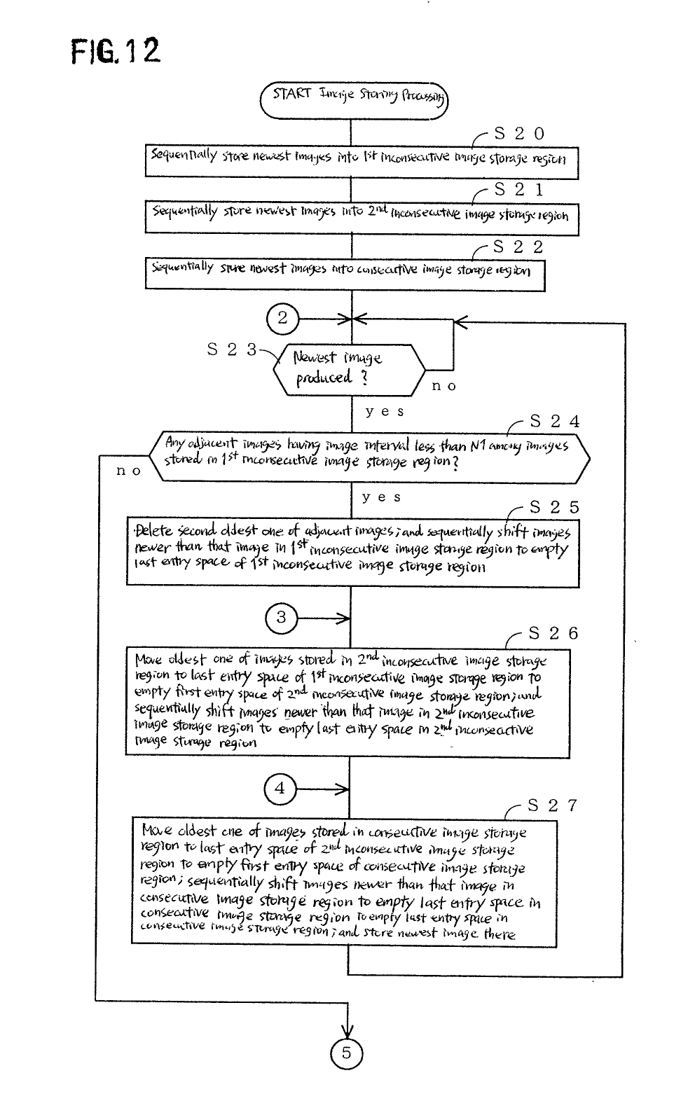

FIG. 12 is a flow chart illustrating image storing processing in accordance with the fourth embodiment.

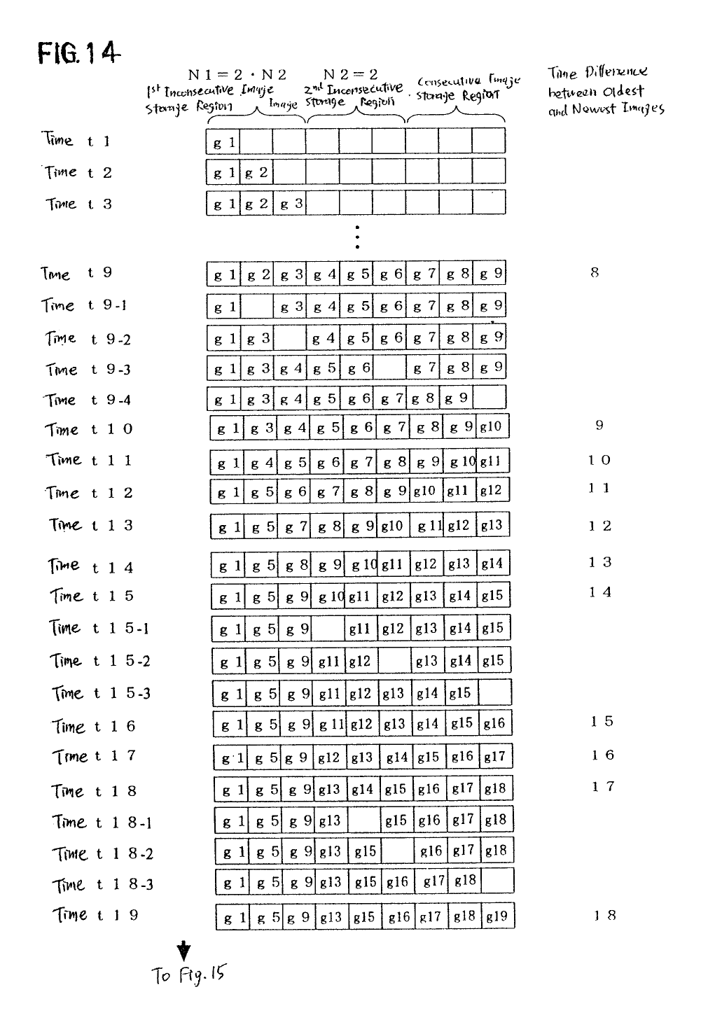

In Step S20, the newest images are sequentially stored into the first inconsecutive image storage region until the region becomes full, as shown at times t1-t3 in FIG. 14.

In Step S21, the newest images are sequentially stored into the second inconsecutive image storage region until the region becomes full.

In Step S22, the newest images are sequentially stored into the consecutive image storage region until the region becomes full.

By Steps S20-S22, the status becomes one shown at time t9 in FIG. 14.

In Step S23, when a newest image is produced, the process goes to Step S24.

In Step S24, the images stored in the first inconsecutive image storage region are searched for adjacent images having an image interval less than “4”. If such adjacent images are found, the process goes to Step S25; otherwise to Step S28. Before the newest image at time t10 in FIG. 14 is stored, the status is at time t9 and the image interval between g1 and g2 is “1”, which is less than “4”. Therefore, g1 and g2 are considered as adjacent images and the process goes to Step S25.

In Step S25, the second oldest one of the adjacent images is deleted, and the images newer than that image in the first inconsecutive image storage region are sequentially shifted to empty the last entry space of the first inconsecutive image storage region. Before the newest image at time t10 in FIG. 14 is stored, g1 and g2 are the adjacent images. Therefore, g2 is deleted as shown at time t9-1 in FIG. 14, and g3 is shifted forward to empty the last entry space of the first inconsecutive image storage region as shown at time t9-2 in FIG. 14.

In Step S26, the oldest one of the images stored in the second inconsecutive image storage region is moved to the last entry space of the first inconsecutive image storage region to empty the first entry space of the second inconsecutive image storage region, and the images newer than that image in the second inconsecutive image storage region are sequentially shifted to empty the last entry space of the second inconsecutive image storage region. Before the newest image at time t10 in FIG. 14 is stored, g4 is moved to the last entry space of the first inconsecutive image storage region to empty the first entry space of the second inconsecutive image storage region, and g5 and g6 are sequentially shifted forward to empty the last entry space of the second inconsecutive image storage region, as shown at time t9-3 in FIG. 14.

In Step S27, the oldest one of the images stored in the consecutive image storage region is moved to the last entry space of the second inconsecutive image storage region to empty the first entry space of the consecutive image storage region; the images newer than that image in the consecutive image storage region are sequentially shifted to empty the last entry space of the consecutive image storage region; and the newest image is stored there. Before the newest image at time t10 in FIG. 14 is stored, g7 is moved to the last entry space of the second inconsecutive image storage region to empty the first entry space of the consecutive image storage region, and g8 and g9 are sequentially shifted forward to empty the last entry space of the consecutive image storage region, as shown at time t9-4 in FIG. 14. Then, the newest image g10 is stored into the last entry space of the consecutive image storage region as shown at t10 in FIG. 14. The process then goes back to Step 23.

At time t11 in FIG. 14, g3 shown at time t10 is deleted, g4-g10 are shifted forward, and the newest image g11 is stored into the last entry space of the consecutive image storage region by Steps S24-S27.

At time t12 in FIG. 14, g4 shown at time t11 is deleted, g5-g11 are shifted forward, and the newest image g12 is stored into the last entry space of the consecutive image storage region by Steps S24-S27.

At time t13 in FIG. 14, g6 shown at time t12 is deleted, g7-g12 are shifted forward, and the newest image g13 is stored into the last entry space of the consecutive image storage region by Steps S24-S27.

At time t14 in FIG. 14, g7 shown at time t13 is deleted, g8-g13 are shifted forward, and the newest image g14 is stored into the last entry space of the consecutive image storage region by Steps S24-S27.

At time t15 in FIG. 14, g8 shown at time t14 is deleted, g9-g14 are shifted forward, and the newest image g15 is stored into the last entry space of the consecutive image storage region by Steps S24-S27.

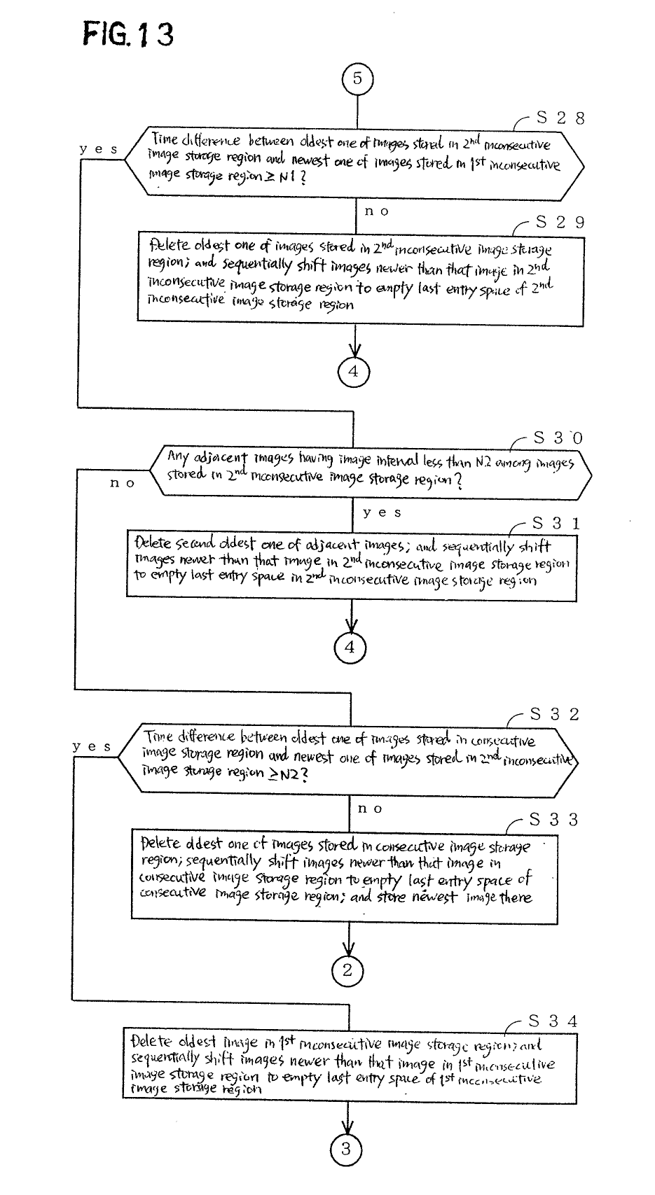

Before the newest image at time t16 in FIG. 14 is stored, the status is at time t15, the process goes from Step S24 to Step S28 in FIG. 13.

In Step S28 in FIG. 13, a decision is made on whether the time difference between the oldest one of the images stored in the second inconsecutive image storage region and the newest one of the images stored in the first inconsecutive image storage region is equal to or more than “4”, and if it is not equal to or more than “4”, the process goes to Step S29; otherwise to Step S30. Before the newest image at time t16 in FIG. 14 is stored, the status is at time t15 and the time difference is “1”, which is not equal to or more than “4”, and therefore the process goes to Step S29.

In Step S29, the oldest one of the images stored in the second inconsecutive image storage region is deleted, the images newer than that image in the second inconsecutive image storage region are sequentially shifted to empty the last entry space in the second inconsecutive image storage region. The process then goes back to Step S27. Before the newest image at time t16 in FIG. 14 is stored, g10 is deleted to empty the first entry space of the second inconsecutive image storage region as shown at time t15-1 in FIG. 13, and g11 and g12 are sequentially shifted forward to empty the last entry space of the second inconsecutive image storage region as shown at time t15-2 in FIG. 14. The process then goes back to Step S27.

Upon returning to Step S27, g13 is moved to the last entry space of the second inconsecutive image storage region to empty the first entry space of the consecutive image storage region, and g14 and g15 are sequentially shifted forward to empty the last entry space of the consecutive image storage region, as shown at time t15-3 in FIG. 14. Then, the newest image g16 is stored into the last entry space of the consecutive image storage region as shown at t16 in FIG. 14. The process then goes back to Step S23.

At time t17 in FIG. 14, g11 shown at time t16 is deleted, g12-g16 are shifted forward, and the newest image g17 is stored into the last entry space of the consecutive image storage region by Steps S24, S28, S29 and S27.

At time t18 in FIG. 14, g11 shown at time t17 is deleted, g13-g17 are shifted forward, and the newest image g18 is stored in the last entry space of the consecutive image storage region by Steps S24, S28, S29 and S27.

Before the newest image at time t19 in FIG. 14 is stored, the status is at time t18, the process goes from Step S24 to Step S28 in FIG. 12, and further goes to Step S30.

In Step S30, the images stored in the second inconsecutive image storage region are searched for adjacent images having an image interval less than “2”, and if such adjacent images are found, the process goes to Step S31; otherwise to Step S32. Before the newest image at time t19 in FIG. 14 is stored, the status is at time t18 and the image interval between g13 and g14 is “1”, which is less than “2”. Therefore, g13 and g14 are considered as adjacent images and the process goes to Step S31.

In Step S31, g14 is deleted to empty the first entry space of the second inconsecutive image storage region as shown at time t18-1 in FIG. 14, and g15 is shifted forward to empty the last entry space of the second inconsecutive image storage region as shown at time t18-2 in FIG. 14. Then, the process goes back to Step S27.

Upon returning to Step S27, g16 is moved to the last entry space of the second inconsecutive image storage region to empty the first entry space of the consecutive image storage region, and g17 and g18 are sequentially shifted forward to empty the last entry space of the consecutive image storage region, as shown at time t18-3 in FIG. 14. Then, the newest image g19 is stored into the last entry space of the consecutive image storage region as shown at t19 in FIG. 14. The process then goes back to Step S23.

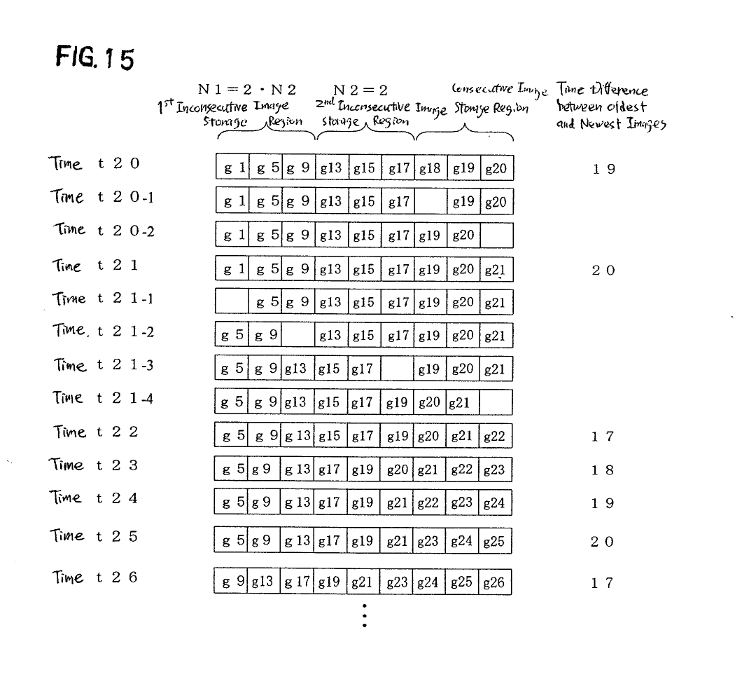

At time t20 in FIG. 15, g16 shown at time t19 is deleted, g17 g19 are shifted forward, and the newest image g20 is stored into the last entry space of the consecutive image storage region by Steps S24, S28, S30 and S31.

Before the newest image at time t21 in FIG. 15 is stored, the status is at time t20, the process goes from Step S24 to Step S28 in FIG. 13, then goes from Step S28 to Step S30, and further to Step S32.

In Step S32, a decision is made on whether the time difference between the oldest one of the images stored in the consecutive image storage region and the newest one of the images stored in the second inconsecutive image storage region is equal to or more than “2”, and if it is not equal to or more than “2”, the process goes to Step S33; otherwise to Step S34. Before the newest image at time t21 in FIG. 15 is stored, the status is at time t20 and the time difference is “1”, which is not more than “2”, and therefore the process goes to Step S33.

In Step S33, the oldest one of the images stored in the consecutive image storage region is deleted; the images newer than that image in the consecutive image storage region are sequentially shifted to empty the last entry space in the consecutive image storage region; and the newest image is stored there. Before the newest image at time t21 in FIG. 15 is stored, g18 is deleted as shown at time t20-1 to empty the first entry space of the consecutive image storage region, and g19 and g20 are sequentially shifted forward to empty the last entry space of the consecutive image storage region as shown at time t20-2. Then, the newest image g21 is stored into the last entry space of the consecutive image storage region as shown at time t21 in FIG. 15. The process then goes back to Step S23.

Before the newest image at time t22 in FIG. 15 is stored, the status is at time t21, the process goes from Step S24 to Step S28 in FIG. 13, from Step S28 to Step S30, from Step S30 to Step 32, and further to Step S34.

In Step S34, the oldest image in the first inconsecutive image storage region is deleted, and the images newer than that image in the first inconsecutive image storage region are sequentially shifted to empty the last entry space of the first inconsecutive image storage region. Then, the process goes back to Step S26. Before the newest image at time t22 in FIG. 15 is stored, g1 is deleted as shown at time t21-1 to empty the first entry space of the first inconsecutive image storage region, and g5 and g9 are sequentially shifted forward as shown at time t21-2 to empty the last entry space of the first inconsecutive image storage region. Then, the process goes back to Step S26.

Upon returning to Step S26, g13 is moved to the last entry space of the first inconsecutive image storage region to empty the first entry space of the second inconsecutive image storage region, and g15 and g17 are sequentially shifted forward to empty the last entry space of the second inconsecutive image storage region, as shown at time t21-3 in FIG. 15.

Next, in Step S27, g19 is moved to the last entry space of the second inconsecutive image storage region to empty the first entry space of the consecutive image storage region, and g20 and g21 are sequentially shifted forward to empty the last entry space of the consecutive image storage region, as shown at time t21-4 in FIG. 15. Then, the newest image g22 is stored into the last entry space of the consecutive image storage region as shown at time t22. The process then goes back to Step S23.

By storing images in a similar way thereafter, images over a longer time period as compared with the conventional technique can be stored.

Although the number of entry spaces in the cine memory 4 was “9” in the preceding description, it is generally of the order of from several tens to several hundreds.

For example, if the number of entry spaces is “400” in which “50” entry spaces are assigned to the consecutive image storage region, “300” entry spaces are assigned to the first inconsecutive image storage region and “50” entry spaces are assigned to the second inconsecutive image storage region, N1=6 and N2=3, and if imaging is performed at a frame rate of 10 frames/second, then images over the latest five seconds can be stored in the consecutive image storage region, images over an intermediate fifteen seconds at maximum can be stored in the second inconsecutive image storage region, and images over oldest three minutes at maximum can be stored in the first inconsecutive image storage region. In contrast, the conventional method allows images over only 40 seconds to be recorded. Since there is a need to reproduce images over about three minutes after a contrast agent is injected into a subject, the present invention can respond to this need.

### Fifth Embodiment

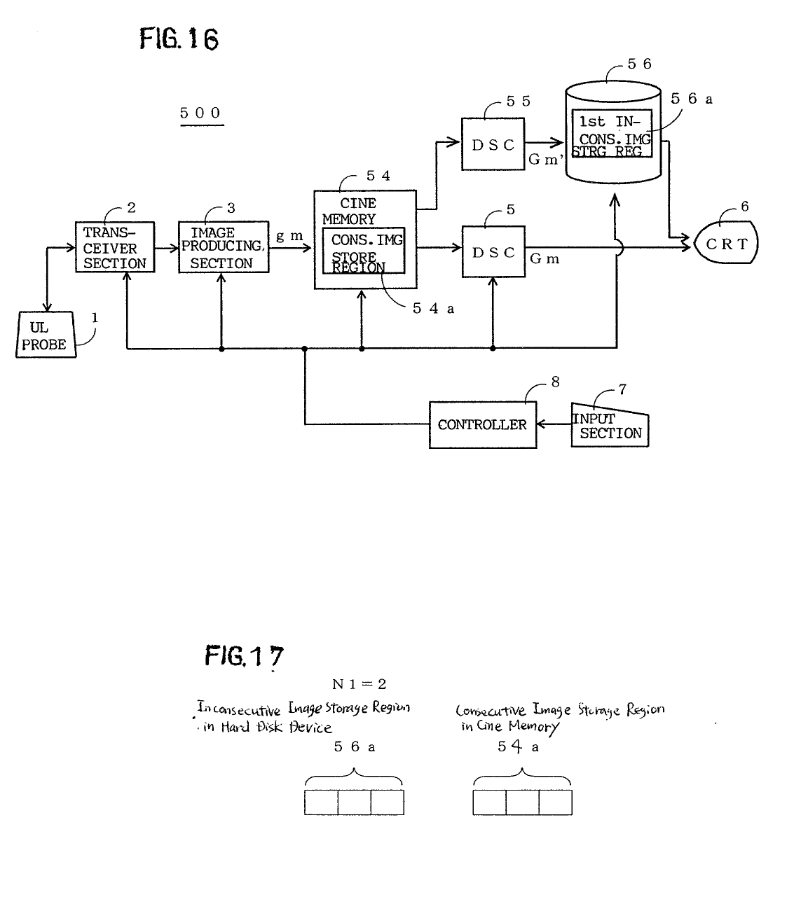

FIG. 16 is a configuration diagram illustrating an ultrasonic diagnosis apparatus 500 in accordance with a fifth embodiment of the present invention.

The ultrasonic diagnosis apparatus 500 comprises an ultrasonic probe 1; a transceiver section 2 for driving the ultrasonic probe 1 to transmit ultrasound and receive echoes, and outputting receive signals based on the echoes; an image producing section 3 for producing images gm (m=1, 2, . . . ) on an acoustic line basis from the receive signals; a cine memory 54 having a consecutive image storage region 54a for storing a plurality of the chronologically consecutive images gm; a DSC 5 for converting the images gm stored in the cine memory 54 into images Gm on a screen picture element basis; a DSC 55 for converting the images stored in the cine memory 54 into images Gm′ on a screen picture element basis; a hard disk device 56 having a first inconsecutive image storage region 56a for storing a plurality of the chronologically inconsecutive images Gm′; a CRT 6 for displaying the images Gm and Gm′; an input section 7 for a human operator to input instructions; and a controller 8 for controlling the storage of images gm into the cine memory 54 and storage of images Gm′ to the hard disk device 56, and controlling the entire apparatus.

FIG. 17 is a schematic diagram showing the configuration of the consecutive image storage region 54a and the first inconsecutive image storage region 56a.

Entry spaces in the consecutive image storage region 54a and those in the first inconsecutive image storage region 56a can be considered as having the same logical structure as those in the cine memory 4 of the first embodiment shown in FIG. 3.

For convenience of explanation, the consecutive image storage region 54a is described as having three entry spaces, and the first inconsecutive image storage region 56a as having three entry spaces.

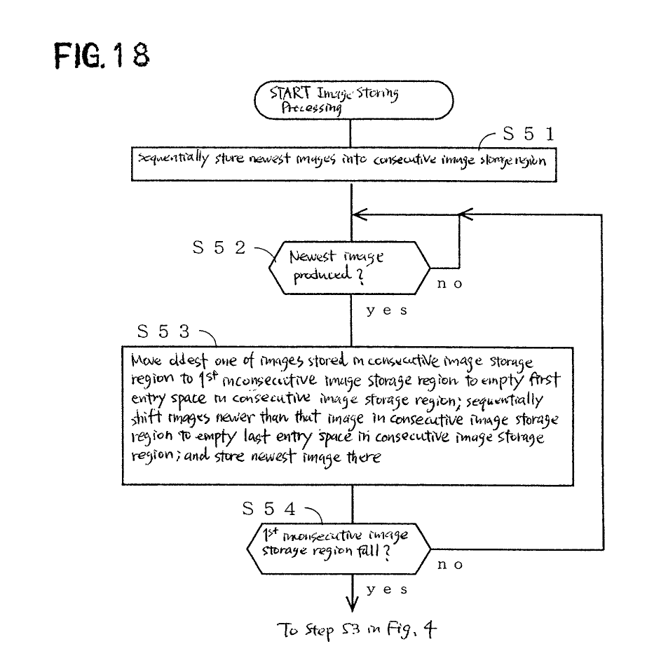

FIG. 18 is a flow chart illustrating image storing processing by the ultrasonic diagnosis apparatus 500.

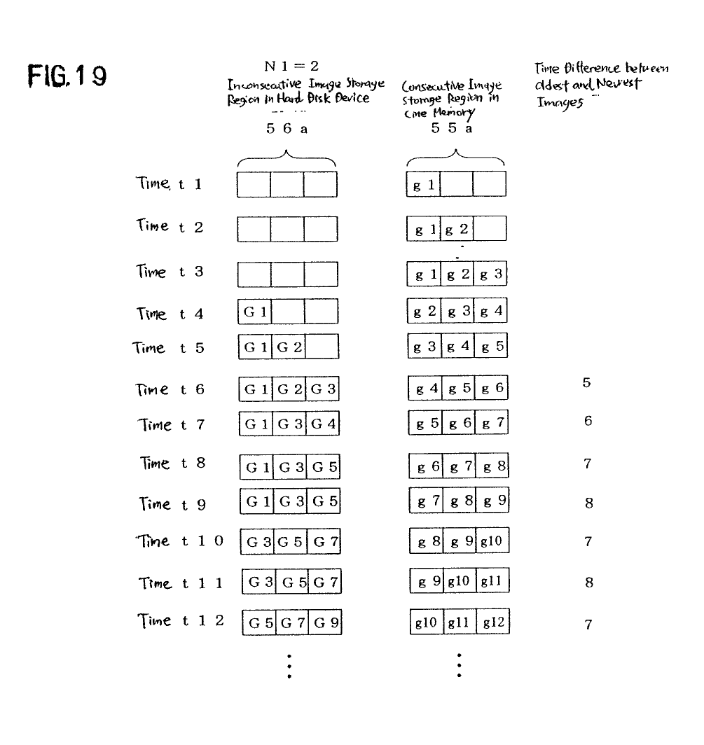

In Step S51, the newest images are sequentially stored into the consecutive image storage region 54a until the region becomes full, as shown at times t1-t3 in FIG. 19.

In Step S52, when a newest image is produced, the process goes to Step S53.

In Step S53, the oldest one of the images stored in the consecutive image storage region 54a is stored into the foremost empty entry space in the first inconsecutive image storage region 56a. Then, the oldest one of the images stored in the consecutive image storage region 54a is deleted to empty the first entry space of the consecutive image storage region 54a ; the images newer than that image in the consecutive image storage region 54a are sequentially shifted to empty the last entry space of the consecutive image storage region 54a ; and the newest image is stored there. At time t4 in FIG. 19, an image g1 is converted into an image G1 by the DSC 55; the image G1 is stored in the foremost empty entry space in the first inconsecutive image storage region 56a; g1 is deleted from the consecutive image storage region 54a ; g2 and g3 are shifted forward; and g4 is stored in the last entry space of the consecutive image storage region 54a.

In Step S54, Steps S52 and S53 are repeated until the first inconsecutive image storage region 56a becomes full, and when the first inconsecutive image storage region 56a has become full, the process goes to Step S3 in FIG. 4. Since the first inconsecutive image storage region 56a becomes full at time t6 in FIG. 18, images are stored from time t7 according to the processing of Step S3 and onward in FIG. 4.

According to the fifth embodiment, by employing the high-speed cine memory 54 as the consecutive image storage region 54a , images can be recorded without difficulty even if the images are produced at a high frame rate. Moreover, by employing the large-capacity hard disk device 56 as the inconsecutive image storage region 56a, images over a very long time can be stored. Although the hard disk device operates at a low speed, no inconvenience results from the low access speed because the images have been chronologically thinned out (i.e., made inconsecutive).

Many widely different embodiments of the invention may be configured without departing from the spirit and the scope of the present invention. It should be understood that the present invention is not limited to the specific embodiments described in the specification, except as defined in the appended claims.

1. An image storing method comprising the steps of:
storing a newest image and a plurality of chronologically consecutive old images preceding said newest image; and
storing a plurality of chronologically inconsecutive images older than the oldest one of said chronologically consecutive images.

2. The image storing method of claim 1, further comprising:
dividing a storage region into a consecutive image storage region and an inconsecutive image storage region;
sequentially storing the newest image and the plurality of chronologically consecutive old images preceding said newest image in order of entry spaces into said consecutive image storage region;
sequentially storing the plurality of chronologically inconsecutive images older than the oldest one of the images stored in said consecutive image storage region in order of entry spaces into said inconsecutive image storage region;
deleting an image in an entry space determined in response to a current image storage pattern in the storage region;
sequentially shifting images in entry spaces subsequent to said entry space forward; and
storing the newest image into the last entry space in said consecutive image storage region.

3. The image storing method of claim 1, further comprising:
overwriting the newest image on an entry space determined in response to the current image storage pattern in the storage region.

4. The image storing method of claim 1, further comprising:
dividing a storage region into a consecutive image storage region, an inconsecutive image storage region and an oldest image storage region;
storing a plurality of chronologically consecutive images into said oldest image storage region at the start of image storing;
storing the newest image and a plurality of chronologically consecutive old images preceding said newest image into said consecutive image storage region; and
storing a plurality of chronologically inconsecutive images older than the oldest one of the images stored in said consecutive image storage region into said inconsecutive image storage region.

5. The image storing method of claim 1, wherein said inconsecutive image storage region consists of a plurality of inconsecutive image storage subregions having different skip numbers.

6. An image storing apparatus comprising:
an image storing device for storing the newest image and a plurality of chronologically consecutive old images preceding said newest image, and storing a plurality of chronologically inconsecutive images older than the oldest one of said chronologically consecutive images; and
a storage updating device for selecting one of the stored images, deleting the image, and storing the newest image.

7. The image storing apparatus of claim 6, wherein: said image storing device consists of a consecutive image storing device and an inconsecutive image storing device, sequentially stores the newest image and a plurality of chronologically consecutive old images preceding said newest image in order of entry spaces into said consecutive image storing device, and sequentially stores a plurality of chronologically inconsecutive images older than the oldest one of the images stored in said consecutive image storing device in order of entry spaces into said inconsecutive image storing device; and said storage updating device deletes an image in an entry space determined in response to a current image storage pattern of said image storing device, sequentially shifts images in entry spaces subsequent to said entry space forward, and stores the newest image into the last entry space in said consecutive image storing device.

8. The image storing apparatus of claim 6, wherein: said storage updating device overwrites the newest image on an entry space determined in response to the current image storage pattern of said image storing device.

9. The image storing apparatus of claim 6, wherein: said image storing device consists of a consecutive image storing device, an inconsecutive image storing device and an oldest image storing device, stores a plurality of chronologically consecutive images into said oldest storing device at the start of image storing, stores the newest image and a plurality of chronologically consecutive old images preceding said newest image into said consecutive image storing device, and stores a plurality of chronologically inconsecutive images older than the oldest one of the images stored in said consecutive image storing device into said inconsecutive image storing device.

10. The image storing apparatus of claim 6, wherein said inconsecutive image storing device consists of a plurality of inconsecutive image storing sub-device having different skip numbers.

11. The image storing apparatus of claim 6, wherein said consecutive image storing device is provided in a first storage device with relatively high speed and small capacity, and at least part of said inconsecutive image storing device is provided in a second storage device with relatively low speed and large capacity.

12. The image storing apparatus of claim 11, wherein said first storage device stores images in a first image format, and said second storage device stores images in a second image format different from said first image format.

13. An ultrasonic diagnosis apparatus comprising the image storing apparatus of claim 6.

14. An ultrasonic diagnosis apparatus, wherein: the apparatus comprises the image storing apparatus of claim 12; said first storage device is a cine memory; said first image format is an image format on an acoustic line basis; said second storage device is a hard disk; and said second image format is an image format on a screen picture element basis.

15. A contrast agent imaging method comprising the steps of:
injecting a contrast agent into a subject; and
performing imaging using an ultrasonic diagnosis apparatus comprising the image storing apparatus of claim 6.
